(19) United States
(12) Patent Application Publication
(10) Pub. No.: US 2025/0083907 A1
(43) Pub. Date: Mar. 13, 2025

(54) Apparatus and Method for Loading Unit Cell

(71) Applicant: LG Energy Solution, Ltd., Seoul (KR)

(72) Inventor: Ah Hyun Oh, Daejeon (KR)

(73) Assignee: LG Energy Solution, Ltd., Seoul (KR)

(21) Appl. No.: 18/726,604

(22) PCT Filed: Feb. 14, 2023
(86) PCT No.: PCT/KR2023/002144

§ 371 Date: Jul. 3, 2024

(30) Foreign Application Priority Data
Feb. 15, 2022 (KR) 10-2022-0019801

(51) Int. Cl. B65G 65/00; G06K 7/14; H01M 10/04

(52) U.S. Cl. CPC B65G 65/005; G06K 7/1413; H01M 10/0404; B65G 2203/044

(57) ABSTRACT

An apparatus for loading a unit cell includes: a plurality of magazines each configured to receive unit cells and configured to be placed into set positions; and a plurality of identification parts provided on the plurality of magazines to identify each of the plurality of magazines. Thus, whether the magazines are normally put may be checked.

### CROSS-REFERENCE TO RELATED APPLICATION

The present application claims the benefit of the priority of Korean Patent Application No. 10-2022-0019801, filed on Feb. 15, 2022, which is hereby incorporated by reference in its entirety.

### TECHNICAL FIELD

The present invention relates to an apparatus and method for loading a unit cell. Particularly, the present invention relates to an apparatus and method for loading a unit cell, in which it is automatically checked whether a magazine, on which the unit cell is loaded, is put into an accurate position.

### BACKGROUND ART

Secondary batteries refer to chargeable and dischargeable batteries, unlike primary batteries that are impossible to charge. Such a secondary battery may be used in the form of a single cell or in the form of a battery module in which a plurality of unit cells are electrically connected to each other according to a type of used external devices.

Secondary batteries are classified into a can type secondary battery, in which an electrode assembly is embedded in a metal can, and a pouch type secondary battery in which an electrode assembly is embedded in a pouch. The pouch-type secondary battery includes an electrode assembly, a pouch accommodating the electrode assembly, and an electrode lead connected to an electrode assembly and protruding out of the pouch. In addition, the electrode assembly has a structure in which a plurality of unit cells having different stacking structure are alternatively disposed.

Here, the unit cells use a magazine for efficiency of loading. That is, the same type unit cells are sequentially loaded into an internal space of the magazine. In other words, a plurality of magazines in which the unit cells having the different stacking structures are loaded are provided. In addition, the plurality of magazines are put into set positions in a process of manufacturing the electrode assembly by a worker.

However, in the process of manufacturing the electrode assembly according to the related art, there is a problem in that it is impossible to check whether the magazines put into the set positions are accurately placed. That is, since the plurality of magazines have the same structure and shape, it is difficult to check whether the magazines are put in the accurate positions, and thus, there is a problem in that defective products are produced due to defective stacking and insufficient capacity of the electrode assembly.

### DISCLOSURE OF THE INVENTION

### Technical Problem

An object of the present invention is to provide an apparatus and method for loading a unit cell, in which magazines (in which unit cells having different stacking structures) are improved to be distinguished from each other so as to check whether the magazines are placed into accurate positions, thereby preventing defective products due to defective stacking and insufficient capacity from being produced.

### Technical Solution

An apparatus for loading a unit cell according to the present invention may include: a plurality of magazines, in which unit cells are loaded, respectively, and which are put into set positions, respectively; plurality of and a identification parts which are provided in the plurality of magazines, respectively, and are differently provided to identify the plurality of magazines, respectively.

The plurality of identification parts may be provided in different colors to identify the plurality of magazines, respectively.

The plurality of identification parts may be provided in different shapes to identify the plurality of magazines, respectively.

The plurality of identification parts may be provided in barcodes having different meanings to identify the plurality of magazines, respectively.

The apparatus for loading the unit cell may further include a sensing part configured to sense the identification part of the magazine put into a set position to compare the sensed identification part with the identification part input into the set position so that, if the identification parts match each other, it is determined as a normal input, and if the identification parts do not match each other, it is determined as a defective input, wherein the sensing part may include a plurality of color sensors configured to sense colors of the identification parts respectively provided in the plurality of magazines.

The plurality of identification parts having different colors may be provided by being applied on surfaces of the plurality of magazines.

The apparatus for loading the unit cell may further include a sensing part configured to sense the identification part of the magazine put into a set position to compare the sensed identification part with the identification part input into the set position so that, if the identification parts match each other, it is determined as a normal input, and if the identification parts do not match each other, it is determined as a defective input, wherein the sensing part may include a plurality of infrared sensors configured to sense shapes of the identification parts respectively provided in the plurality of magazines.

The apparatus for loading the unit cell may further include a sensing part configured to sense the identification part of the magazine put into a set position to compare the sensed identification part with the identification part input into the set position so that, if the identification parts match each other, it is determined as a normal input, and if the identification parts do not match each other, it is determined as a defective input, wherein the sensing part may include a plurality of barcode scanners configured to scan barcodes that are the identification parts respectively provided in the plurality of magazines.

The unit cells may be provided as a plurality of unit cells having differently stacked structures, and wherein the plurality of unit cells having the differently stacked structures may be loaded into the plurality of magazines, respectively.

A method for loading a unit cell may include: a process (a) of preparing a plurality of identification parts, which are differently provided to be identified, and a plurality of magazines for loading unit cells; a process (b) of providing the plurality of identification part in the plurality of magazines, respectively; and a process (c) of loading the unit cells into the plurality of magazines to put the plurality of magazines, into which the unit cells are loaded, at set positions, respectively.

In the process (a), the plurality of identification parts may be provided in different colors.

The plurality of identification parts having different colors may be provided by being applied on surfaces of the plurality of magazines.

The method for loading the unit cell may further include, after the process (c), a process (d) of sensing the identification part of the magazine put into a set position through the sensing part to compare the sensed identification part with the identification part input into the set position so that, if the identification parts match each other, it is determined as a normal input, and if the identification parts do not match each other, it is determined as a defective input.

In the process (d), the sensing part may include a plurality of color sensors configured to sense colors of the identification parts respectively provided in the plurality of magazines.

In the process (a), the unit cells may be provided as a plurality of unit cells having differently stacked structures, wherein the unit cells having the differently stacked structures may be loaded into the plurality of magazines, respectively.

### Advantageous Effects

In the apparatus for loading the unit cell according to the present invention, whether the magazine is placed into the accurate position may be checked to prevent the defective product due to the defective stacking and the insufficient capacity from being produced.

### BRIEF DESCRIPTION OF THE DRAWINGS

FIG. 1 is a perspective view illustrating an apparatus for loading a unit cell according to a first embodiment of the present invention.

FIG. 2 is a front view of the apparatus of FIG. 1.

FIG. 3 is a flowchart illustrating a method for loading a unit cell according to the first embodiment of the present invention.

FIG. 4 is a perspective view illustrating an apparatus for loading a unit cell according to a second embodiment of the present invention.

FIG. 5 is a perspective view illustrating an apparatus for loading a unit cell according to a third embodiment of the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

### [Unit Cell According to the Present Invention]

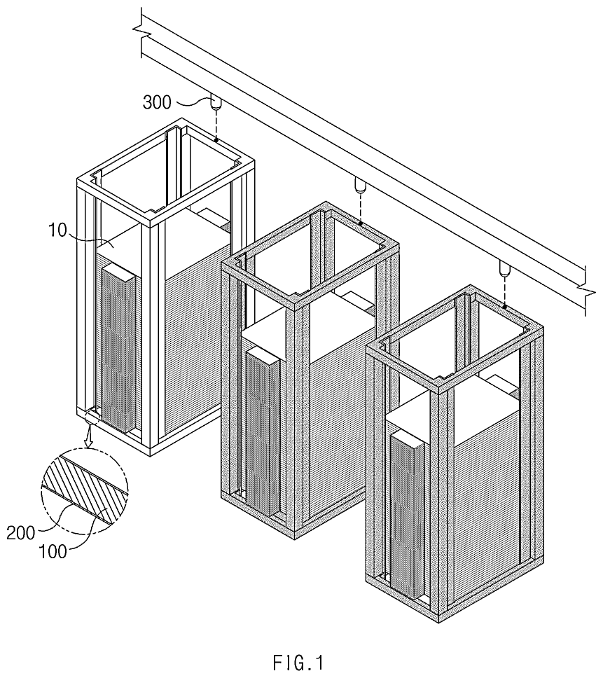

Referring to FIG. 1, a unit cell 10 according to the present invention includes a plurality of unit cells having differently stacked structures. For example, the plurality of unit cells 10 may include a first unit cell and a second unit cell, which have the differently stacked structures, and the first unit cell has a structure in which a separator, a first electrode, and a separator are alternately disposed. In addition, the second unit cell may have a structure in which a second electrode, a separator, a first electrode, and a separator are alternately disposed.

Here, the first electrode may be a positive electrode, the second electrode may be a negative electrode, and vice versa.

As described above, the plurality of unit cells having the differently stacked structures (hereinafter, referred to as a plurality of unit cells) are put into set positions in a process of manufacturing an electrode assembly through an apparatus for loading the unit cell according to a first embodiment of the present invention.

Particularly, in the apparatus for loading the unit cell according to the first embodiment, whether the magazines put into the set positions are accurately put may be automatically inspected to prevent defective products due to and insufficient capacity from being defective stacking produced.

Hereinafter, the apparatus for loading the unit cell according to the first embodiment of the present invention will be described in detail with reference to the accompanying drawings.

### [Apparatus for Loading a Unit Cell According to First Embodiment of the Present Invention]

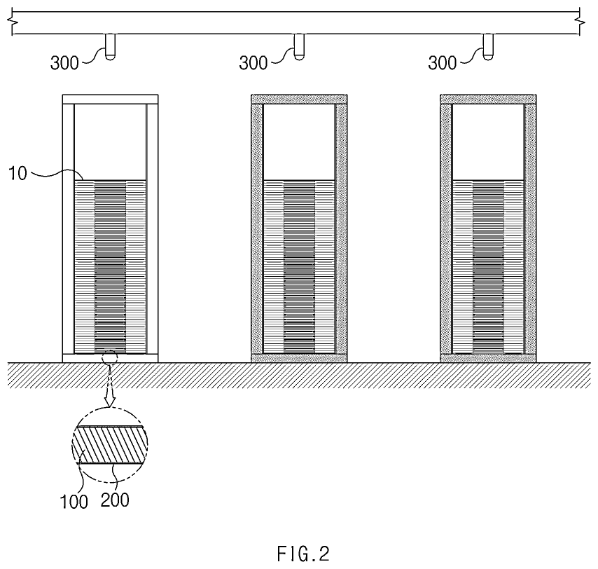

FIG. 1 is a perspective view illustrating an apparatus for loading a unit cell according to a first embodiment of the present invention, and FIG. 2 is a front view of the apparatus FIG. 1.

As illustrated in FIGS. 1 and 2, an apparatus for loading a unit cell according to a first embodiment of the present invention has a structure in which a plurality of magazines 100, in which unit cells 10 are loaded, respectively, are identified.

That is, the apparatus for loading the unit cell according to the first embodiment of the present invention includes a plurality of magazines 100, in which a plurality unit cells 10 are loaded, respectively, and a plurality of identification parts 200, which are provided in or on the plurality of magazines 100 to identify the plurality of magazines 100, respectively.

### Magazine

The magazine 100 is configured to load each of the plurality of unit cells 10 in multiple stages (in a vertical direction when viewed in FIG. 1). That is, referring to FIG. 1, the magazine 100 includes a bottom frame on which the unit cell 10 is loaded, and a support connected to an edge of the bottom frame to support a side portion of the unit cell 10. That is to say, the magazine 100 may have a frame structure in which the bottom frame and the support form a rectangular parallelepiped shape so that a load may be loaded therein.

The magazine 100 having such a structure may be put into a set position in a process of manufacturing the electrode assembly, and thus, the plurality of unit cells loaded in the magazines may be easily put into the set positions.

### Identification Part

An identification part 200 is configured to identify the plurality of magazines. That is, the identification part 200 is provided in plurality so as to be provided in the plurality of magazines 100, respectively. Here, the plurality of identification parts 200 are provided differently from each other to identify the plurality of magazines 100, respectively.

For example, the plurality of identification parts 200 are provided with different colors to identify the plurality of magazines 100, respectively. That is, the plurality of identification parts 200 have different colors, and thus, the plurality of identification parts 200 having the different colors are provided in the plurality of magazines 100 to identify (or classify) the plurality of identification parts 200, respectively. That is to say, whether the placed loads are defective may be easily checked through the colors of the identification part 200 of the magazines 100 installed at the set positions. Particularly, defective loading of the unit cells may be prevented through the identification part of the magazine.

Here, the plurality of identification parts 200 having the different colors may be provided while being applied to the entire surface of each of the plurality of magazines 100. Thus, anyone may easily identify the plurality of magazines 100, and as a result, installation defects of the magazines 100 may be easily identified.

The identification part 200 may be made of an insulating material, and in particular, the identification part 200 may be made of polypropylene.

Here, the plurality of identification parts 200 may be provided in red (R), green (G), and blue (B) so that a color sensor described later senses the colors.

The apparatus for loading the unit cell according to the first embodiment of the present invention may further include a sensing part 300 for automatically sensing the identification part 200 provided in the magazine 100.

### Sensing Part

The sensing part 300 is provided at a set position at which the magazine 100 is placed and senses the identification part 200 of the magazine 100 placed at the set position to compare the sensed identification part 200 with the identification part input at the set position. Then, if the identification parts match each other, it is determined as normal input, and if the identification parts do not match each other, it is determined as defective input. Thus, it is possible to automatically check whether the magazine 100 is accurately placed.

Particularly, if the sensing part 300 does not identify the identification part 200 provided in the magazine 100 for a set time due to the magazine 100 being incorrectly placed into the set position, it is determined as defective input.

The sensing part 300 may include a plurality of color sensors for sensing the colors of the identification parts 200, which are provided in the plurality of magazines 100, respectively. That is, the color sensor may accurately sense the colors of the plurality of identification parts 200 provided in the plurality of magazines 100, and as a result, whether the magazine 100 is placed normally (e.g., accurately) or defectively may be accurately inspected.

When the color sensor emits light having RGB components to the plurality of magazines 100, the color components of the reflected light are changed according to the colors of the identification parts 200 provided in the magazines 100. That is, when the identification part 200 is red (R), the reflected light component is red, when the identification part 200 is green (G), the reflected light component is green, and when the identification part 200 is blue (B), the component of reflected light is blue. As described above, the color sensor senses the color of the identification part 200 by sensing the reflected color, and thus, whether the installation of the magazine 100 is defective may be inspected.

As seen in FIG. 1, the color sensor may be fixed to an upper portion of the magazine 100 through a frame, and thus, when the magazine 100 is installed, interference with the color sensor may be prevented.

As described above, the color sensor may automatically inspect whether the installation of the magazine 100 is defective, and as a result, work efficiency may be greatly improved. Particularly, since the identification part 200 is applied on an entire surface of the magazine 100, the color sensor may stably sense the identification part 200 provided in the magazine 100, and as a result, the inspection accuracy may be improved.

Therefore, the apparatus for loading the unit cell according to the first embodiment of the present invention may include the plurality of magazines 100, the plurality of identification parts 200, and the sensing parts 300 to automatically inspect whether the plurality of magazines 100 are put into the correct positions, thereby preventing defective loading and defective products.

Hereinafter, a method for loading a unit cell according to the first embodiment of the present invention will be described.

### [Method for Loading Unit Cell According to the First Embodiment of the Present Invention]

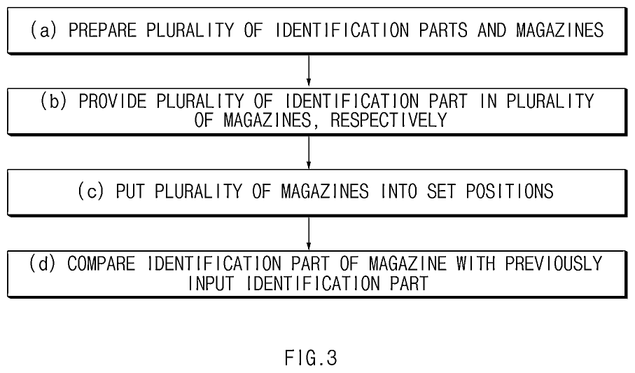

FIG. 3 is a flowchart illustrating a method for loading a unit cell according to the first embodiment of the present invention.

As illustrated in FIG. 3, a method for loading a unit cell according to the first embodiment of the present invention includes a process (a) of preparing a plurality of identification parts 200 provided differently so as to be identified and a plurality of magazines 100 for loading a unit cell 10, a process (b) of providing the plurality of identification parts 200 to the plurality of magazines 100, respectively, and a process (c) of loading the unit cell 10 into each of the plurality of magazines 100 to put the plurality of magazines 100, in which the unit cells 10 are loaded, into set positions, respectively.

Particularly, the method for loading the unit cell according to the first embodiment of the present invention further include, after the process (c), a process of sensing the identification part 200 provided in the magazine through a sensing part 300 to inspect whether the magazine 100 put at the set position is accurately placed.

### Process (a)

In the process (a), the plurality of different identification parts 200 are prepared to be identified. That is, in the process (a), the plurality of identification parts 200 having different colors are prepared. Here, the plurality of identification parts 200 may be provided in red (R), green (G), and blue (B) so that the color sensor may sense the colors.

In addition, in the process (a), the plurality of magazines 100 for loading the unit cells 10 are prepared. Each of the magazines 100 includes a bottom frame on which the unit cell 10 is loaded, and a support connected to an edge of the bottom frame to support a side portion of the unit cell 10.

### Process (b)

In the process (b), the plurality of identification parts 200 having the different colors are respectively provided on an entire surface of the plurality of magazines 100. Here, the plurality of identification parts 200 may be provided by preparing a pigment and then applying the pigment to the entire surface of the plurality of magazines 100. Then, the plurality of magazines 100 have colors of the applied identification parts 200. It is contemplated that the pigment need not be applied to the entire surface of each of the plurality of the magazines, e.g., the pigment may be applied to a portion of the surface of each of the magazines, but there may be advantages to applying the pigment to the entire surface as described above.

### Process (c)

In the process (c), unit cells are loaded into the magazines 100 coated with the identification part 200. Here, the plurality of unit cells 10 having differently stacked structures are loaded in the plurality of magazines 100, respectively. Next, the plurality of magazines 100, in which the unit cells 10 are loaded, are put into the set positions in the process of manufacturing the electrode assembly, respectively.

### Process (d)

In the process (d), the identification parts 200 of the magazines 100 put into the set positions are sensed through the sensing parts 300, and then, the sensed identification parts 200 are compared with the identification parts input to the setting positions. Here, if the identification parts 200 match each other, it is determined as a normal (e.g., accurate) input, and if the identification parts do not match each other, it is determined as a defective input.

Here, the sensing parts 300 may be provided as a plurality of color sensors. That is, the color sensors sense the colors of the identification parts 200 of the magazines 100 put into the installation positions and then compare the colors of the identification parts input to the set positions with each other. Here, if the identification parts 200 have the same color, it is determined as the normal input, and if the identification parts 200 have different colors, it is determined as the defective input.

The color sensors may be installed at all sides of the magazines 100, and thus, the identification parts 200 provided in the magazines 100 may be more accurately identified to improve measurement accuracy.

Therefore, in the method for loading the unit cell according to the first embodiment of the present invention, whether the plurality of magazines 100 are installed at the accurate positions may be automatically inspected to prevent loading defects and product defects from occurring.

Hereinafter, in descriptions of another embodiment of the present invention, constituents having the same configuration and function as the above-mentioned embodiment have been given the same reference numeral in the drawings, and thus duplicated description will be omitted.

### [Apparatus for Loading Unit Cell According to Second Embodiment of the Present Invention]

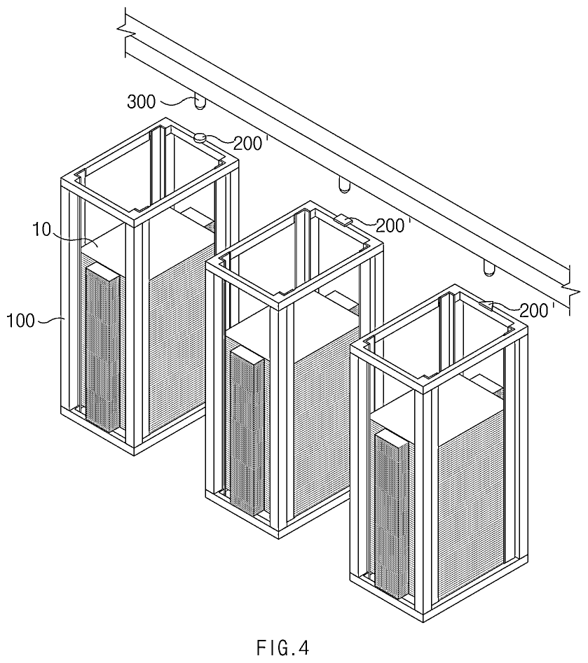

FIG. 4 is a perspective view illustrating an apparatus for loading a unit cell according to a second embodiment of the present invention.

As illustrated in FIG. 4, an apparatus for loading a unit cell according to a second embodiment of the present invention includes a plurality of magazines 100 and a plurality of identification parts 200′ which are provided in the plurality of magazines 100 to identify the plurality of magazines 100, respectively.

Here, the plurality of identification parts 200′ are provided in different shapes to identify the plurality of magazines 100, respectively.

For example, the plurality of identification parts 200′ may include any one of a triangular identification part, a rectangular identification part, and a circular identification part.

Thus, the apparatus for loading the unit cell according to the second embodiment of the present invention may easily identify the plurality of magazines 100 with the naked eye.

The apparatus for loading the unit cell according to the second embodiment of the present invention may further include sensing parts 300′ that sense and inspect the plurality of identification parts 200′ respectively provided in the plurality of magazines 100.

Particularly, the sensing parts 300′ are provided with a plurality of infrared sensors that sense shapes of the identification parts 200′ respectively provided in or on the plurality of magazines 100. Thus, the plurality of infrared sensors photograph the identification parts 200′ provided in the plurality of magazines 100, measure the identification parts 200′ from photographed images, and compare the measured identification parts 200′ with the previously input identification part. Here, if the identification parts match each other, it is determined as normal (e.g., accurate) installation, and if the identification parts do not match each other, it is determined as defective installation.

Therefore, the apparatus for loading the unit cell according to the second embodiment of the present invention may accurately check whether the magazines put into the set positions are normally put through the plurality of identification parts 200′ having different shapes.

### [Apparatus for Loading Unit Cells According to a Third Embodiment of the Present Invention]

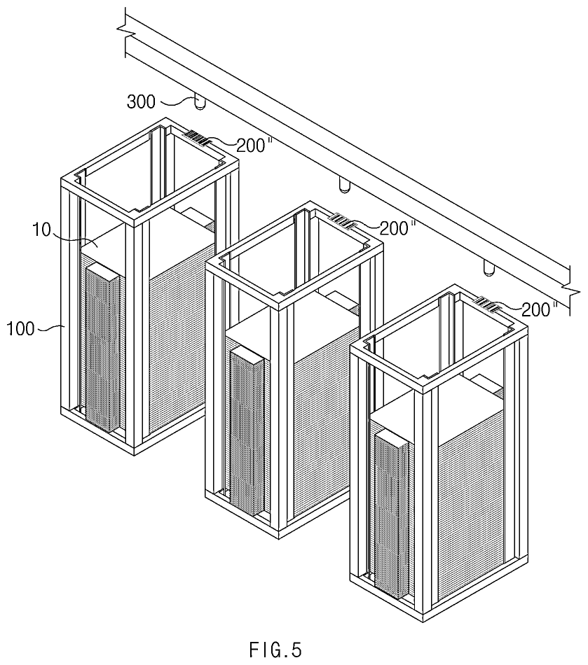

FIG. 5 is a perspective view illustrating an apparatus for loading a unit cell according to a third embodiment of the present invention.

As illustrated in FIG. 5, an apparatus for loading a unit cell according to a third embodiment of the present invention includes a plurality of magazines 100 and a plurality of identification parts 200″ which are provided in the plurality of magazines 100 to identify the plurality of magazines 100, respectively.

Here, the plurality of identification parts 200″ are provided in barcodes having different meanings or patterns to identify the plurality of magazines 100, respectively.

Here, the apparatus for loading the unit cell according to the third embodiment of the present invention may further include sensing parts 100 that sense the plurality of identification parts 200″ respectively provided in the plurality of magazines 100. Particularly, the sensing parts 300″ are provided as a plurality of barcode scanners that scan bar codes, which are identification parts respectively provided in the plurality of magazines 100.

That is, the barcode scanners scan the identification parts 200″ provided in the magazines 100 and then compare the scanned barcodes with barcodes of the identification part previously input at the set positions. Here, if the identification parts match each other, it is determined as normal (e.g., accurate) installation, and if the identification parts do not match each other, it is determined as defective installation.

Therefore, the apparatus for loading the unit cell according to the third embodiment of the present invention may accurately check whether the magazines put into the set positions are normally or accurately placed through the plurality of identification parts 200″ having the different barcodes.

Accordingly, the scope of the present invention is defined by the appended claims more than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

10: Unit cell
100: Magazine
200: Identification part
300: Sensing part

1. An apparatus for loading a unit cell, the apparatus comprising:
a plurality of magazines each configured to receive unit cells and configured to be placed into set positions; and
a plurality of identification parts provided on the plurality of magazines to identify each of the plurality of magazines.

2. The apparatus of claim 1, wherein the plurality of identification parts are provided in different colors to identify the plurality of magazines.

3. The apparatus of claim 1, wherein the plurality of identification parts are provided in different shapes to identify the plurality of magazines.

4. The apparatus of claim 1, wherein the plurality of identification parts are provided in barcodes having different patterns to identify the plurality of magazines.

5. The apparatus of claim 2, further comprising a sensing part configured to sense each of the plurality of identification parts of each of the plurality of magazines put into the set positions to compare a sensed identification part with an identification part input into the set position, so that, if the sensed identification parts matches the identification part input into the set position, a normal input is determined by the sensing part, and if the sensed identification part does not match the identification part input into the set position, a defective input is determined by the sensing part,
wherein the sensing part comprises a plurality of color sensors configured to sense colors of the plurality of identification parts respectively provided on the plurality of magazines.

6. The apparatus of claim 2, wherein the plurality of identification parts having different colors are provided by being applied on respective surfaces of the plurality of magazines.

7. The apparatus of claim 3, further comprising a sensing part configured to sense each of the plurality of identification parts of each of the plurality of magazines put into the set positions to compare a sensed identification part with an identification part input into the set position, so that, if the sensed identification part matches the identification part input into the set position, a normal input is determined by the sensing part, and if the sensed identification parts does not match the identification part input into the set position, a defective input is determined by the sensing part,
wherein the sensing part comprises a plurality of infrared sensors configured to sense shapes of the plurality of identification parts respectively provided in the plurality of magazines.

8. The apparatus of claim 4, further comprising
a sensing part configured to sense the plurality of identification parts of the plurality of magazines put into the set positions to compare a sensed identification part with an identification part input into the set position, so that if the sensed identification parts matches the identification part input into the set position, a normal input is determined by the sensing part, and if the sensed identification parts does not match the identification part input into the set position, a defective input is determined by the sensing part,
wherein the sensing part comprises a plurality of barcode scanners configured to scan barcodes that are on the plurality of identification parts.

9. The apparatus of claim 1, wherein the unit cells are provided as a plurality of unit cells having differently stacked structures, and
wherein the plurality of unit cells having the differently stacked structures are loaded into the plurality of magazines.

10. A method for loading a unit cell, the method comprising:
preparing a plurality of identification parts and a plurality of magazines for loading unit cells therein;
providing the plurality of identification parts on the plurality of magazines, respectively; and
loading the unit cells into the plurality of magazines to place the plurality of magazines at set positions, respectively.

11. The method of claim 10, wherein the plurality of identification parts are provided in different colors.

12. The method of claim 11, wherein the plurality of identification parts having different colors are applied on surfaces of the plurality of magazines.

13. The method of claim 11, further comprising, after loading the unit cells into the plurality of magazines, sensing an identification part of a magazine put into a set position with a sensing part to compare the sensed identification part with the identification part input into the set position, so that, if the sensed identification parts matches the identification part input into the set position, a normal input is determined by the sensing part, and if the sensed identification parts does not match other the identification part input into the set position, a defective input is determined by the sensing part.

14. The method of claim 12, wherein the sensing part comprises a plurality of color sensors configured to sense colors of the identification parts respectively provided in the plurality of magazines.

15. The method of claim 10, wherein the unit cells are provided as a plurality of unit cells having differently stacked structures, and
wherein the unit cells having the differently stacked structures are loaded into the plurality of magazines, respectively.
